(19) United States
(12) Patent Application Publication
(10) Pub. No.: US 2007/0152982 A1
(43) Pub. Date: Jul. 5, 2007

(54) Input device supporting various input modes and apparatus using the same

(75) Inventors: Kyu-yong Kim, Yongin-si (KR); Sang-youn Kim, Seoul (KR); Yong-beom Lee, Seoul (KR); Byung-seok Soh, Suwon-si (KR); Gyung-hye Yang, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/590,742

(22) Filed: Nov. 1, 2006

(30) Foreign Application Priority Data
Dec. 29, 2005 (KR) 10-2005-0133904

(51) Int. Cl. G06F 3/041

(52) U.S. Cl. 345/173

(57) ABSTRACT

An input device for adaptively providing various input modes according to an aspect of the present application and providing a clicking feeling to a user by controlling the stiffness of a button pressed by the user is provided. The input device includes a contact surface (physically) contacting a user, an actuator providing a displacement or a force to the contact surface, and an electric circuit controlling the operation of the actuator.

### CROSS-REFERENCE TO RELATED APPLICATION

This application claims priority from Korean Patent Application No. 10-2005-0133904 filed on Dec. 29, 2005 in the Korean Intellectual Property Office, the disclosure of which is incorporated herein by reference in its entirety.

### BACKGROUND OF THE INVENTION

1. Field of the Invention

The present invention relates to an input device, and more particularly, to an input device adaptively providing various input modes according to a current application and an apparatus for providing haptic feedback to a user by controlling the stiffness of a button according to the state of a current application.

2. Description of the Related Art

With the development of information and telecommunication technology including Internet and computers, many digital devices satisfying the tastes and demands of customers have been manufactured and are now being widely used. Recently, digital devices such as mobile phones, personal digital assistants (PDAs), portable multimedia players (PMPs), digital cameras, portable gameplayers, and MP3 players characterized by convenient portability have particularly attracted customer interest. However, due to their properties, portable apparatuses inevitably have a more limited input/output interface, i.e., a display device and a user input device, than desktop computers, digital televisions, etc.

Examples of a user input device used for portable apparatuses are a key, a button, a track ball, a touch pad, and a touch screen. A portable apparatus includes one or more of such input devices depending on its intended use. Meanwhile, many integrated portable apparatuses having multiple functions have been developed. For example, a mobile phone is equipped with multiple functions including an MP3 player function, a digital camera function, and a portable gameplayer function.

To realize multiple functions with a single portable apparatus, various user input devices appropriate for the individual functions are needed. For example, to enjoy games, a four-direction button is needed. To make a call, number keys are needed. To input a memo by handwriting, a touch pad is needed.

FIGS. 1A and 1B illustrate conventional portable apparatuses including multiple input devices, in which FIG. 1A illustrates a conventional portable apparatus 10 including a display unit 11 implemented by a liquid crystal display (LCD), a light emitting diode (LED), or an organic LED (OLED); a number key input device 12; and a touch pad 13.

To make a call, a user inputs a telephone number by pressing keys in the number key input device 12. A user can input a handwritten memo by writing the memo on the touch pad 13 with a stylus pen 14.

FIG. 1B illustrates another conventional portable apparatus 20 including key input devices 22 and 23 having different functions. To enjoy games, a user can select a direction in which to move using a four-direction key input device 22. To enjoy movies, a user can input a Play command, a Stop command, and other control commands using a multimedia key input device 23. When a menu displayed on a display unit 21 is moved and/or selected using the four-direction key input device 22, the four-direction key input device 22 may function as the multimedia key input device 23. However, users may be inconvenienced in this case as compared to a case where an exclusive key is provided.

The conventional portable apparatuses 10 and 20 illustrated in FIGS. 1A and 1B include multiple input devices, but these input devices have a large size or the size of other elements such as display units 11 and 21 forming the appearance of the portable apparatuses 10 and 20 needs to be reduced, which is, however, opposed to the recent trend of compactness, lightness, and a wide display of a portable apparatus.

### SUMMARY OF THE INVENTION

Additional aspects and/or advantages of the invention will be set forth in part in the description which follows and, in part, will be apparent from the description, or may be learned by practice of the invention.

The present invention provides an input device which is implemented within a limited area and adaptively changes according to multiple applications.

The present invention also provides an apparatus for providing haptic feedback by controlling the stiffness of the input device according to an application state when a user command is input using the input device.

According to an aspect of the present invention, there is provided an input device including a contact surface to contact a user, an actuator providing a displacement or a force to the contact surface, and an electric circuit to control the operation of the actuator. The actuator includes an electro-active polymer layer including an electro-active polymer and a plurality of electrodes to contact the electro-active polymer, a first variable-mode button is actuated on the contact surface when power is supplied to a electrode combination among the plurality of electrode, and a second variable-mode button is actuated on the contact surface when power is supplied to another electrode combination among the plurality of electrode. In addition, the first variable-mode button may be different from the second variable-mode button in terms of at least one among a position, a number and a size.

According to another aspect of the present invention, there is provided a input device including a contact surface (physically) to contact a user, an actuator providing a displacement or a force to the contact surface, and an electric circuit to control the operation of the actuator, wherein the actuator comprises an electro-active polymer layer including an electro-active polymer and a plurality of electrodes to contact the electro-active polymer and a touch pad layer to sense a position of pressure applied by a user, a button mode is activated when power is supplied to a predetermined electrode combination among the plurality of electrodes, and a touch pad mode is activated when power supplied to the plurality of electrodes is turned off.

According to still another aspect of the present invention, there is provided a portable apparatus including a microprocessor to load an application module corresponding to an application selected by a user into a memory and execute the loaded application module, a display module to display to the user an execution procedure or an execution result of the application module, and an input device to provide alternatively the user with a button mode or a touch pad mode mapped to the application in response to a control signal from the microprocessor.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B illustrate conventional portable apparatuses including multiple input devices;

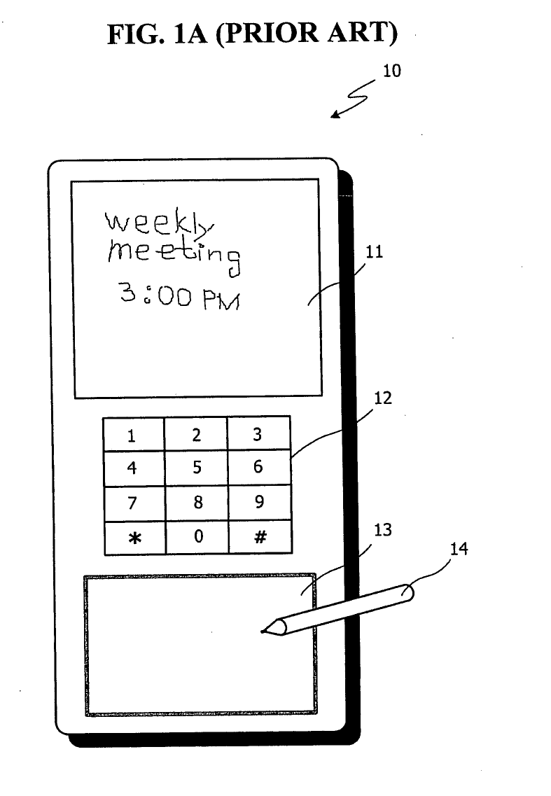

FIGS. 2A and 2B illustrate the characteristics of an electro-active polymer and particularly a dielectric polymer;

FIG. 3 illustrates an example of a portable apparatus including an input device according to an embodiment of the present invention;

FIG. 4 illustrates the appearance of the input device illustrated in FIG. 3;

FIG. 5 illustrates 15 pairs of electrodes arranged in the input device illustrated in FIG. 3;

FIGS. 6A and 6B are perspective views of states in which a variable-mode button is generated by driving only one electrode among the electrodes illustrated in FIG. 5;

FIGS. 7A through 7E illustrate input devices having various structures according to embodiments of the present invention;

FIG. 8 illustrates a force-displacement curve obtained when a metal dome is clicked on in an embodiment of the present invention;

FIG. 9 illustrates an example in which a telephone number is input using any one of the input devices illustrated in FIGS. 7A through 7E;

FIG. 10 illustrates an example in which a handwritten memo is input using the input device illustrated in FIG. 7A;

FIG. 11 illustrates an example in which a command is input using any one of the input devices illustrated in FIGS. 7A through 7E during game play;

FIG. 12 illustrates an example in which a control command is input using any one of the input devices illustrated in FIGS. 7A through 7E during video playback;

FIG. 13 illustrates an input device including a variable-mode button that includes a plurality of upper and lower electrodes, according to an embodiment of the present invention;

FIG. 14 is a cross-section of an electro-active polymer layer in the variable-mode button illustrated in FIG. 13; and

FIG. 15 is a block diagram of a portable apparatus according to an embodiment of the present invention.

### DETAILED DESCRIPTION OF THE PREFERRED EMBODIMENTS

The present invention will now be described more fully with reference to the accompanying drawings, in which preferred embodiments of the invention are shown. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals in the drawings denote like elements.

EAPs (Electro-active Polymer) are, polymers that have a wide range of physical and electrical properties.

Upon application of an electrical current, EAPs exhibit a considerable displacement or strain, generally called deformation. Such strain may differ depending on the length, width, thickness, or radial direction of a polymer material, and it is known that the strain is in a range of 10% to 50%, which is a very characteristic feature compared to a piezoelectric element which exhibits a strain only as high as about 3%. Therefore, it is advantageous in that the EAP can be almost completely controlled by a suitable electric system.

The EAP has various advantages, such as small size, easy controllability, low power consumption, high response speed, or low potential cost. Due to such advantages, EAPs are currently being actively researched and developed in a wide variety of applications, such as artificial muscles, or the like.

Since the EAP outputs an electric signal corresponding to an external physical strain applied, if any, it can be used as sensor as well. Since materials of EAP typically generate a potential difference that can be electrically measured, the EAP can be used as a sensor of force, location, speed, accelerated speed, pressure, and so on. In addition, since the EAP has bi-directional property, it can also be used as a sensor or an actuator.

Known examples of the EAP include gel, ionic polymer metal composite (IPM), electro-resistrictive polymer, and the like. Mechanism of most of EAP materials is based on ions moving inside and outside a polymeric network. Among the above stated EAPs, the electro-resistrictive polymer is known as the most practical polymer from the commercial point of view.

The electro-resistrictive polymer can be divided into two types: a dielectric type; and a shape-transition type. The dielectric type polymer is generally disposed such that a conductive electrode and a compliant electrode are sandwiched with the dielectric type polymer interposed therebetween. Under a high electric field, e.g., several hundreds to several thousands of volts, an attractive force associated with the electrodes presses dielectric materials, resulting in a large amount of deformation, i.e., approximately 50%.

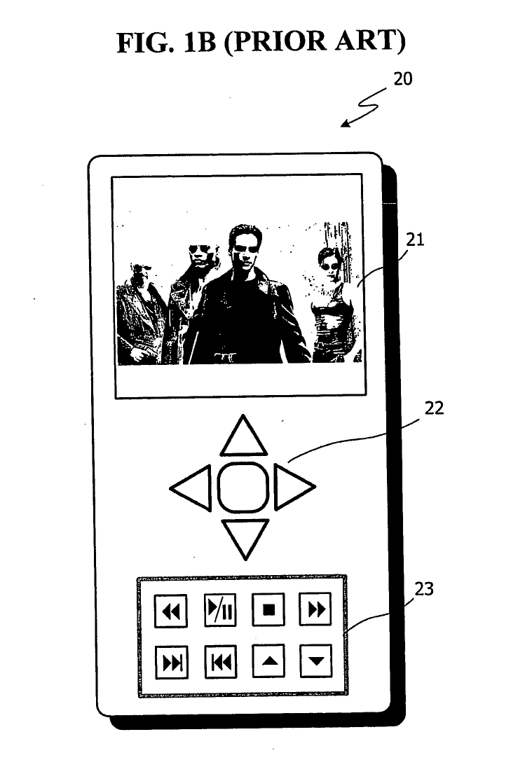

FIGS. 2A and 2B illustrate the characteristics of an electro-active polymer and particularly a dielectric polymer. The present invention provides an input device whose mode can be converted into various input modes using an electro-active polymer. In the description hereinbelow, an electric polymer is used as the electro-active polymer.

Referring to FIG. 2A, two electrodes 32a and 32b respectively contact two sides of an electro-active polymer 31 having a predetermined thickness. Each of the two electrodes 32a and 32b is made of a thin film of a conductive polymer and a compliant polymer so that it can be transformed following the transformation of the electro-active polymer 31.

When power from a power source 30 is not supplied to the electrodes 32a and 32b, the electro-active polymer 31 is in an initial state as illustrated in FIG. 2A. When the power of the power source 30 is supplied to the electrodes 32a and 32b, the electro-active polymer 31 is transformed such that it becomes thinner and expander as illustrated in FIG. 2B. Here, the flexible electrodes 32a and 32b are transformed following the transformation of the electro-active polymer 31.

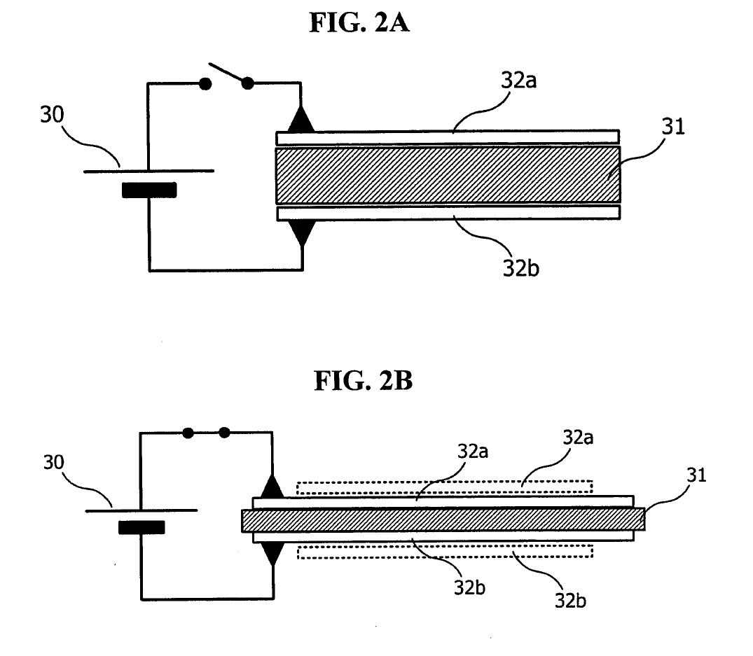

FIG. 3 illustrates an example of a portable apparatus 300 including an input device 100 according to an embodiment of the present invention. The portable apparatus 300 allows a user to input commands in various modes (e.g., a video playback mode, a game mode, a call mode, and a handwriting input mode) with the single input device 100, which has a limited size. When a command is input, the electro-active polymer 31 (not shown) disposed in the single input device 100 tactually guides a person's finger or a stylus pen. Accordingly, the input device 100 needs a smaller area than conventional input devices. As a result, the size of the portable apparatus 300 can be reduced or a larger-size display 301 can be secured.

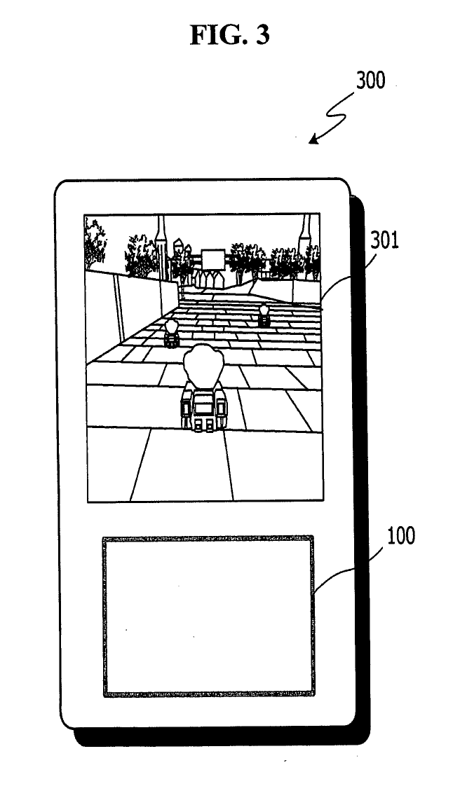

FIG. 4 illustrates the appearance of the input device 100 illustrated in FIG. 3.

Referring to FIG. 4, the input device 100 includes an input surface 99 receiving a user's touch input. The input device is divided into a predetermined number of grid sections 41. A variable-mode button 40 can be generated at each of the grid sections 41. In the input device 100 illustrated in FIG. 4, a total of five by three buttons, i.e., fifteen buttons, can be selectively generated for example.

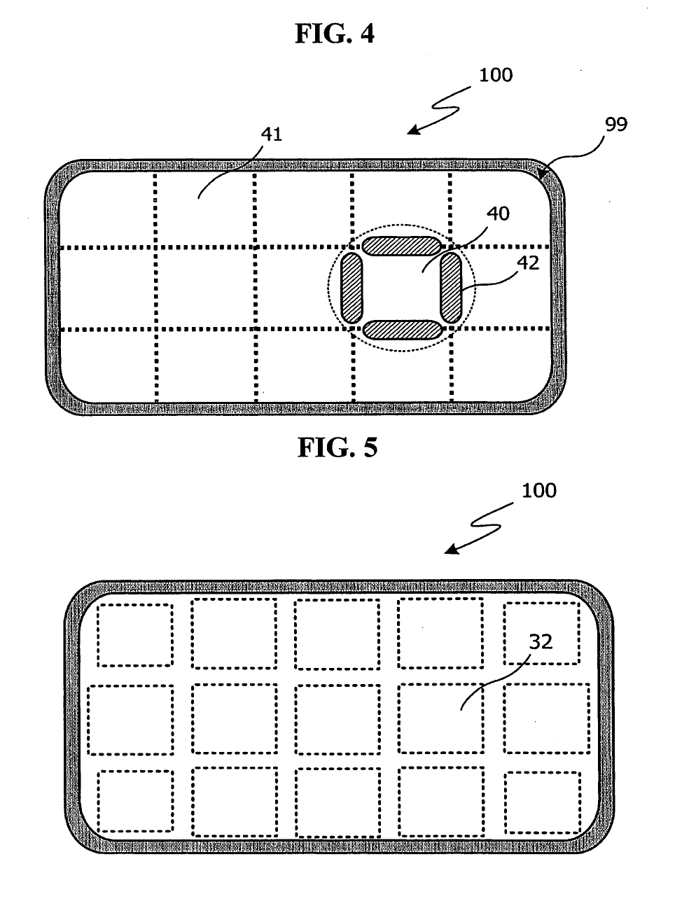

The grid sections 41 are determined according to the size and shape of an electrode 32 (FIG. 5) driving the electro-active polymer 31. If fifteen electrodes 32 are arranged on the input surface 99 of the input device 100 as illustrated in FIG. 5, a single grid section 41 and a single variable-mode button 40 may be formed per one electrode 32.

The variable-mode button 40 can be visually or tactually perceived by a user through protrusions 42 formed edges of the grid sections 41.

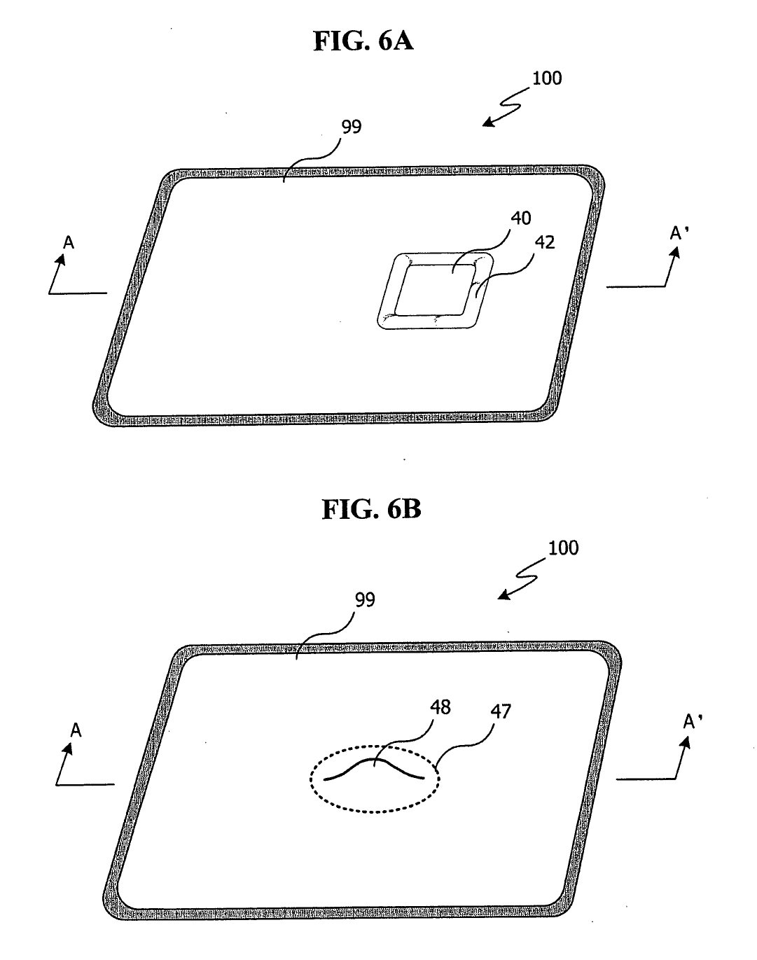

FIG. 6A is a perspective view of a state in which the variable-mode button 40 is generated by driving only one among the electrodes 32 illustrated in FIG. 5. In FIG. 6A, the shape of the variable-mode button 40 is similar to a rectangle since the electrodes 32 have a rectangular shape in FIG. 5. Accordingly, the shape of the variable-mode button 40 can be varied by using electrodes 32 having other shapes like a circle and a polygon for example.

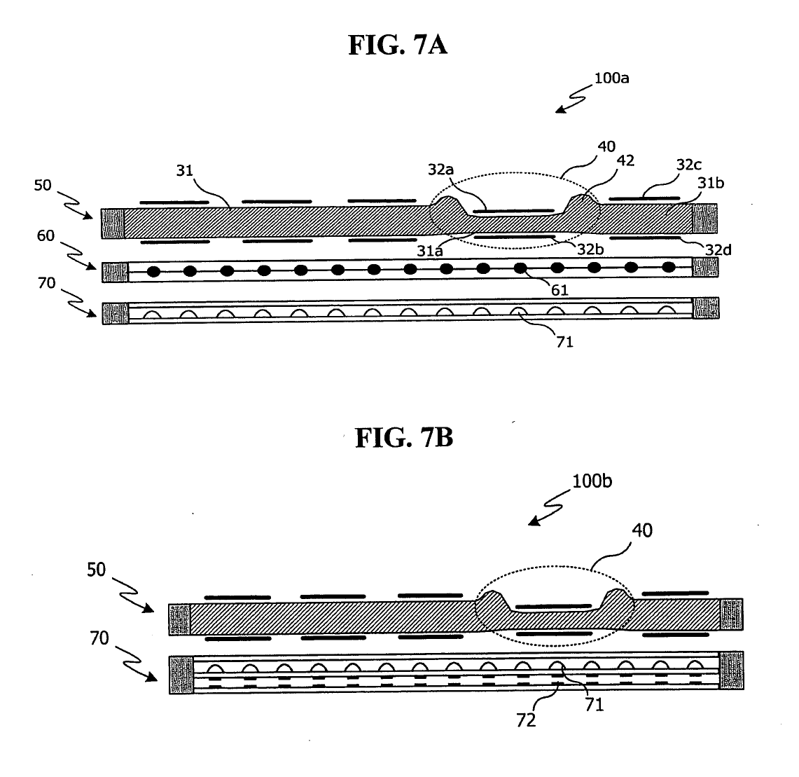

Meanwhile, the protrusions 42 may be disposed at the edges of the variable-mode button 40, as illustrated in FIG. 6A. Alternatively, as illustrated in FIG. 6B, a central portion 48 of a variable-mode button 47 may protrude. Various examples of the variable-mode buttons 40 and 47 illustrated in FIGS. 6A and 6B will be described with reference to FIGS. 7A through 7E below.

FIGS. 7A through 7E illustrate input devices having various structures according to embodiments of the present invention, in which FIGS. 7A through 7C are cross-sectional views taken along the line A-A′ illustrated in FIG. 6A.

FIG. 7A illustrates an input device 100a including an electro-active polymer layer 50, a touch pad layer 60, and a metal (or a rubber) dome layer 70, according to an embodiment of the present invention. The layers 50, 60, and 70 are substantially in contact with each other.

The electro-active polymer layer 50 may include an electro-active polymer 31 expanding to a predetermined thickness, the electrode 32 disposed to be in contact with a top side and a bottom side of the electro-active polymer 31, and a power source (not shown) applying a voltage to the electrode 32.

When the voltage is applied to the particular electrodes 32a and 32b included in the electrode 32, a portion 31a of the electro-active polymer 31 contacting the electrodes 32a and 32b is expanded in a direction parallel to the electrodes 32a and 32b. However, the voltage is not applied to other electrodes 32c and 32d included in the electrode 32 and a portion of the electro-active polymer 31 corresponding to the electrodes 32c and 32d is not expanded but remains in an initial state. Accordingly, folds or protrusions 42 are formed in the electro-active polymer 31 between the particular electrodes 32a and 32b and the other electrodes 32c and 32d. The protrusions 42 may be formed upward or downward but are preferably formed upward since the bottom side of the electro-active polymer layer 50 is supported by the other layers 60 and 70 or a case.

When a user presses the protrusions of the variable-mode button 42, an electrode grid 61 included in the touch pad layer 60 is stimulated and it is recognized that there is a command input with respect to a corresponding position.

Generally, the touch pad layer 60 operates in response to a user's finger motion and a downward pressure. The touch pad layer 60 includes the electrode grid 61, in which electrode lines are arranged in horizontal and vertical directions, and a circuit board (not shown) connected with the electrode grid 61. A constant alternating current is applied to the electrode grid 61. When a predetermined pressure is applied to the electrode grid 61, the current flow is interrupted and the interruption of the current flow is recognized by the circuit board.

The metal dome layer 70 may be formed below the touch pad layer 60 to provide a clicking feeling to the user. Since the position of the variable-mode button 40 pressed by the user can be recognized by the touch pad layer 60, the metal dome layer 70 does not need to separately include a contact switch.

If the clicking feeling is not necessary, the metal dome layer 70 may be eliminated. However, if it is considered that input mistakes or the like can be prevented when a user can tactually perceive the press-down of a button, the metal dome layer 70 may be used according to an aspect of the present invention.

According to an embodiment of the present invention, the metal dome layer 70 is used to give the clicking feeling, but it is apparent that other means such as a rubber dome and a spring may be used.

FIG. 7B illustrates an input device 100b including the electro-active polymer layer 50 and the metal dome layer 70, according to an embodiment of the present invention. Compared to the input device 100a illustrated in FIG. 7A, the touch pad layer 60 is eliminated, and instead, the metal dome layer 70 includes a metal dome 71 and a contact switch 72.

When the variable-mode button 40 is pressed by a user, a clicking feeling is provided by the metal dome 71 and simultaneously the contact switch 72 therebelow is turned on so that a position of the variable-mode button 40 can be recognized. Metal domes 71 and contact switches 72 may be uniformly arranged throughout the input surface 99 (FIG. 6A) of the input device 100b, as illustrated in FIG. 7B. Alternatively, a single metal dome 71 and a single switch 72 may be disposed for each variable-mode button 40.

FIG. 7C illustrates an input device 100c including only the electro-active polymer layer 50, according to an embodiment of the present invention. FIG. 7C illustrates a shape of the variable-mode button 40 formed in the electro-active polymer layer 50 when a voltage is applied to the electrodes 32a and 32b. When a user presses the variable-mode button 40, a change in the voltage applied to the electrodes 32a and 32b is recognized, whereby the downward pressure applied to the variable-mode button 40 is sensed. For example, after a voltage of 5 V is applied to initially generate the variable-mode button 40, if a user presses the variable-mode button 40, a change in the voltage occurs. When the change exceeds a predetermined threshold value, a determination may be made that the variable-mode button 40 has been pressed.

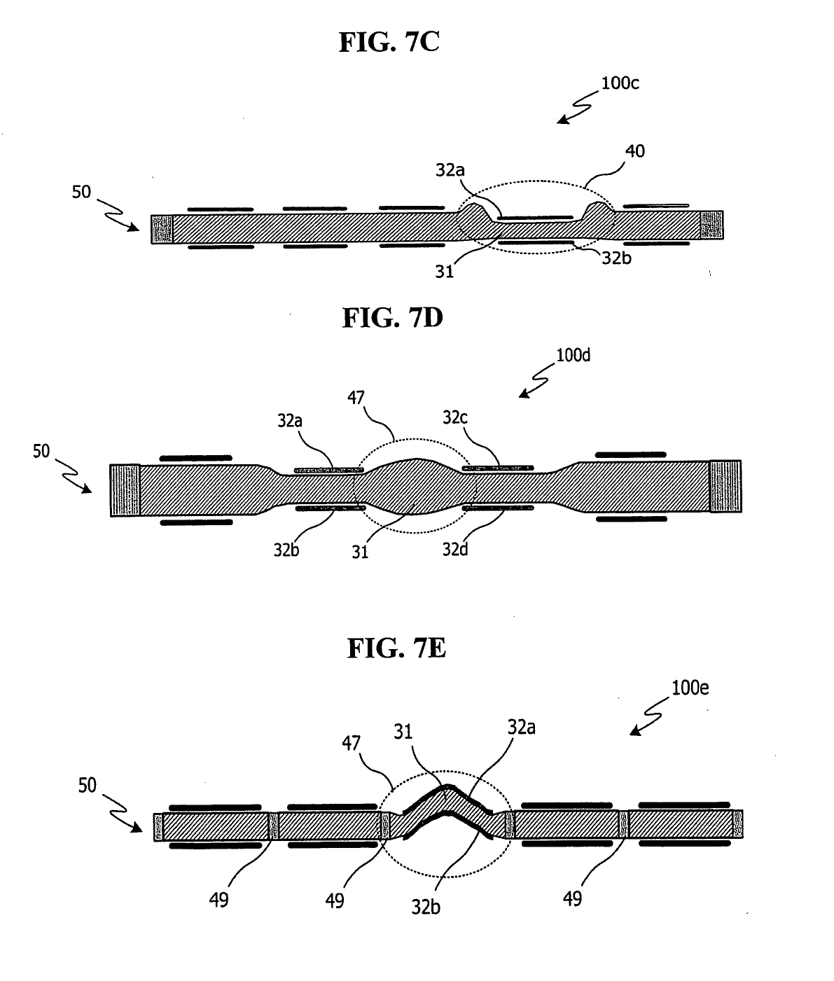

In addition, when it is determined that the variable-mode button 40 has been pressed, a voltage having a predetermined waveform may be applied to the electrodes 32a and 32b to provide haptic stimulus to a user. The predetermined waveform may be a periodical waveform such as a sine wave, a triangle wave, or a square wave or may be a waveform similar to a force-displacement curve obtained when a metal dome is pressed, as illustrated in FIG. 8. When the predetermined waveform is applied to the electrodes 32a and 32b, a force or displacement corresponding to the waveform occurs in the electro-active polymer portion 31a. The force or displacement is transferred as a haptic feeling to a user pressing the variable-mode button 40.

FIGS. 7D and 7E illustrate examples of a cross-section of the input device 100 taken along the line A-A′ illustrated in FIG. 6. Referring to FIG. 7D, when a voltage is applied to two pairs of the electrodes 32a and 32b and 32c and 32d adjacent to a portion at which the variable-mode button 47 will be formed, portions of the electro-active polymer 31 contacting the electrodes 32a through 32d are expanded. Accordingly, a portion of the electro-active polymer 31 between the two pairs of the electrodes 32a and 32b and 32c and 32d is thicker than the expanded portions and forms the variable-mode button 47.

Referring to FIG. 7E, a region is defined for each electrode and the electro-active polymer 31 is separately driven in each region to form a variable-mode button 47. Here, a fixing portion 49 is formed at a border of each region to prevent the electro-active polymer 31 from moving in a horizontal direction. The electro-active polymer layer 50 may be implemented by a plurality of small electro-active polymers included in the respective regions and defined by fixing portions 49. Alternatively, the electro-active polymer layer 50 may be implemented by a single electro-active polymer divided into regions by the fixing portion 49.

In any case, when a voltage is applied to a pair of electrodes 32a and 32b, only the electro-active polymer 31 included in a corresponding region is expanded. Since the ends of the electro-active polymer 31 are fixed by the fixing portion 49, the expanded electro-active polymer 31 protrudes upward as illustrated in FIG. 7E, whereby the variable-mode button 47 is formed.

In input devices 100d and 100e illustrated in FIGS. 7D and 7E, like the input device 100c illustrated in FIG. 7C, the electro-active polymer 31 simultaneously functions as an actuator and a sensor. However, like the input devices 100a and 100b illustrated in FIGS. 7A and 7B, the input devices 100d and 100e may further include the touch pad layer 60 or the metal dome layer 70.

In the input devices 100d and 100e, the amount of protrusion is proportional to a voltage applied to the electrodes. When the amount of protrusion increases, stiffness felt by a user contacting the variable-mode button 47 also increases. Accordingly, the user can adaptively change the stiffness of the variable-mode button 47 to a current application state by controlling the voltage applied to the electrodes.

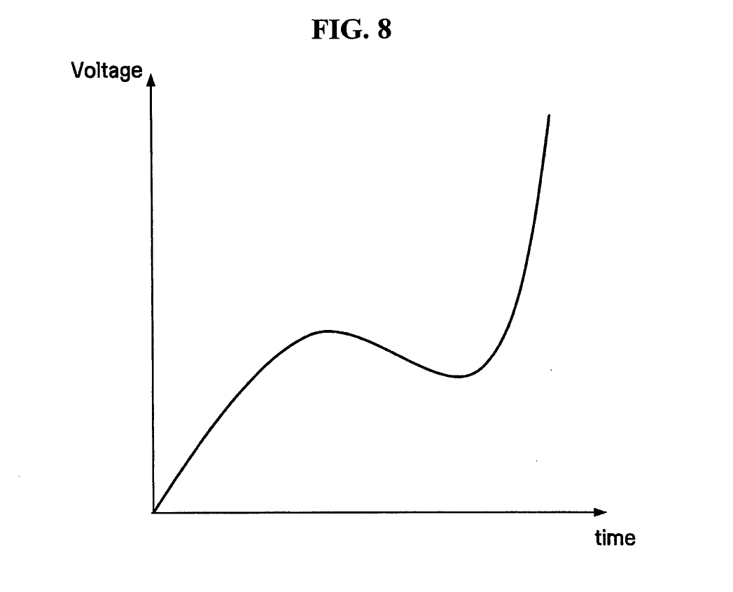

FIG. 9 illustrates an example in which a telephone number is input using any one of the input devices 100a through 100e illustrated in FIGS. 7A through 7E. When a user changes the mode of the portable apparatus 300 into a telephone number input mode, fifteen variable-mode buttons respectively corresponding to keys on a screen keyboard 39 displayed on a display unit 301 are activated. Then, the user can input a number by pressing a variable-mode button at a position corresponding to a desired key among the fifteen variable-mode buttons. When a variable-mode button is “activated”, the user can visually or tactually recognize a position of the variable-mode button. In addition, when the variable-mode button is pressed, a corresponding command can be input by pressing the variable-mode button.

The fifteen variable-mode buttons may be simultaneously activated or only the variable-mode button 40 at a position currently touched by a user may be activated. In the latter case, visual signs (e.g., enlargement or color change) may be added to the screen keyboard 39 so that the user can easily identify a key 38 corresponding to a position that the user is touching. When the user moves his/her finger (or a stylus pen) on the input surface 99 of the input device 100, the special expression and the variable-mode button 40 are moved. Thereafter, when the user presses the variable-mode button 40 at a desired position a corresponding number is input.

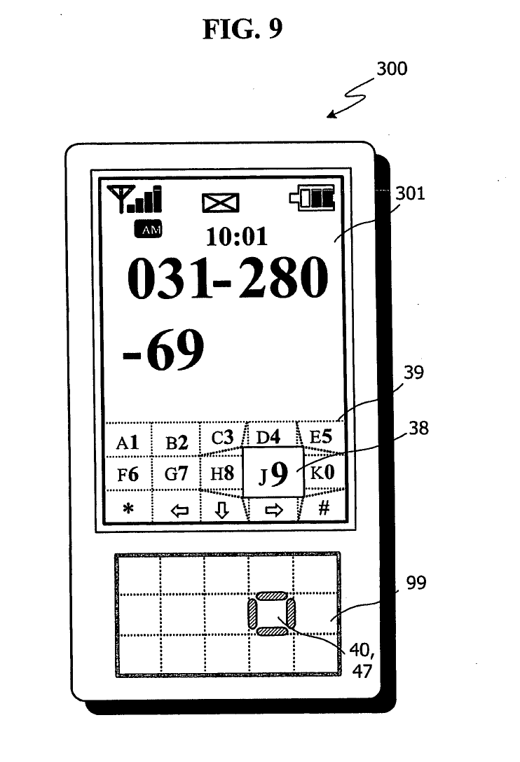

FIG. 10 illustrates an example in which a handwritten memo is input using the input device 100a illustrated in FIG. 7A.

When a user changes the mode of a the portable apparatus 300 into a handwriting input mode, the power source to all electrodes formed in the electro-active polymer layer 50 is turned off and the touch pad layer 60 acts like a normal touch pad. Accordingly, the electro-active polymer 31 of the electro-active polymer layer 50 returns to the initial state (i.e., a uniform flat shape). In this situation, when the user writes a memo with a stylus pen 14 on the input surface 99, the electrode grid 61 formed in the touch pad layer 60 senses the movement of the stylus pen 14 and a written memo corresponding to the movement is displayed on the display unit 301.

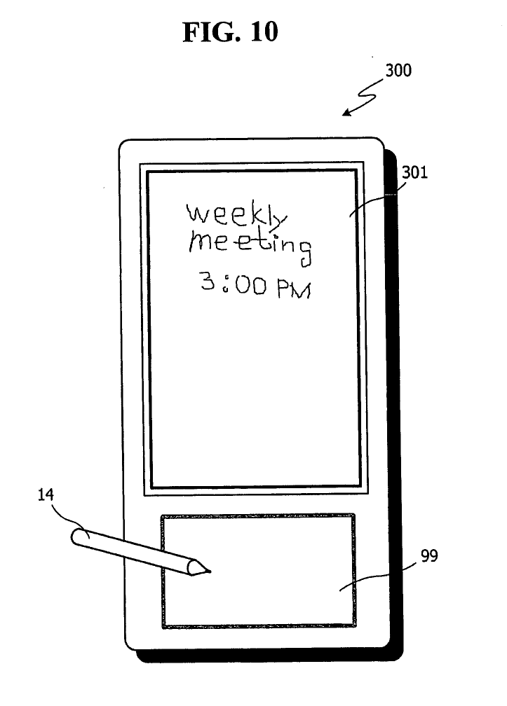

FIG. 11 illustrates an example in which a command is input using any one of the input devices 100a through 100e illustrated in FIGS. 7A through 7E during gameplay.

When a user changes the mode of the portable apparatus 300 into a game mode, variable-mode buttons 43, 44, 45, and 46 respectively corresponding to four direction keys are activated on the input surface 99. Other buttons necessary for the gameplay may also be additionally activated. Since the user can perceive the positions of the respective variable-mode buttons 43, 44, 45, and 46 tactually as well as visually, the user can accurately press a desired variable-mode button while keeping user's eyes on the display unit 301 on which a game image is displayed.

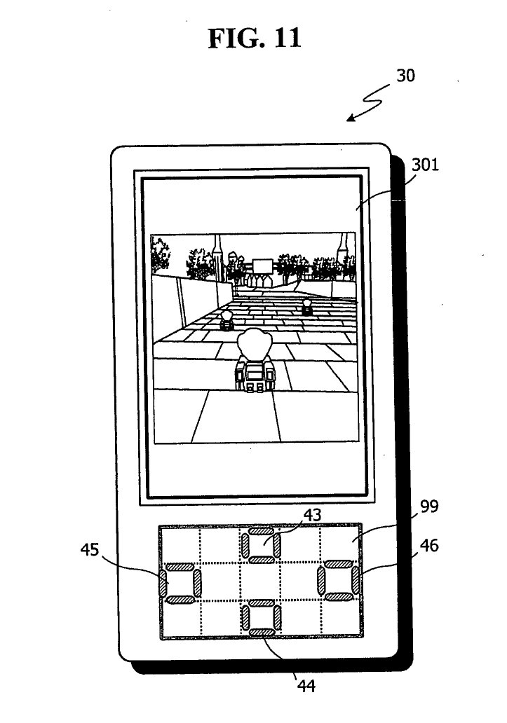

FIG. 12 illustrates an example in which a control command is input using any one of the input devices 100a through 100e illustrated in FIGS. 7A through 7E during video playback.

When a user starts multimedia playback, icons 37 indicating control commands such as Play, Pause, Fast Forward, and Volume Up/Down are displayed on the display unit 301 together with a multimedia image.

Similarly to the example illustrated in FIG. 9, the variable-mode button 40 is activated according to the movement of the user's finger (or a stylus pen) touching the input surface 99. Here, a special expression (e.g., enlargement or color change) appears in an icon corresponding to the activated variable-mode button 40. Accordingly, the user can identify a control command corresponding to the current variable-mode button 40. Thereafter, when the user presses the variable-mode button 40, the corresponding control command is executed. It may not necessary to move the touching finger across the input surface 99 to identify a corresponding control command.

The user may directly press a position on the input surface 99 corresponding to a position of a desired control command on the display unit 301 to execute the desired control command. As illustrated in FIG. 12, when the icons 37 indicating nine control commands are arranged in two rows such that five icons are lined in one row and four icons are lined in the other row, five grid sections on a first row and first four grid sections on a third row among fifteen grid sections on the input surface 99 may be respectively matched to the icons at corresponding positions.

All of nine variable-mode buttons corresponding to the 9 icons may be activated at a moment when a video playback mode is selected, regardless of user's touch.

Referring to FIGS. 9 and 12, a screen key or an icon corresponding to an input is displayed as an assistant guide on the display unit 301. However, a user can choose whether or not to display the screen key or icon because, although a user initially using the portable apparatus 300 may need the assistant guide, a user familiar with the portable apparatus 300 may become familiar with the key arrangement corresponding to a particular mode.

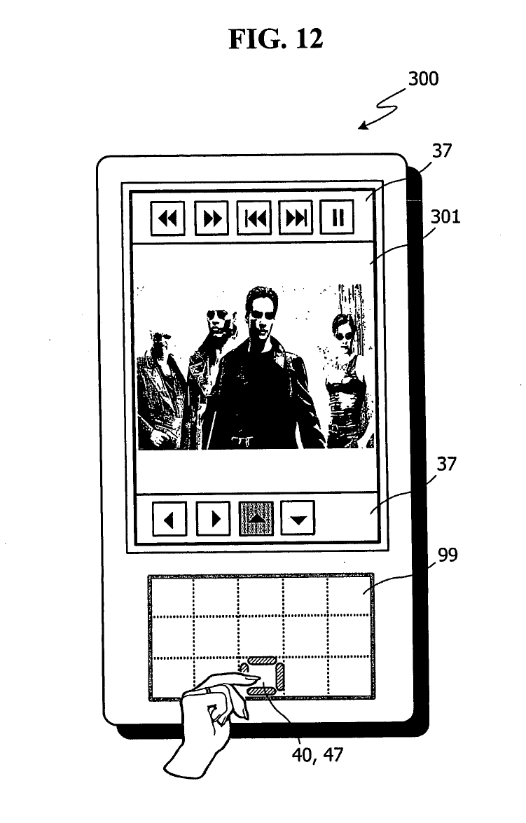

In the above-described embodiments of the present invention, a single variable-mode button includes a pair of the upper and lower electrodes 32a and 32b. However, in an input device 110 illustrated in FIG. 13 according to another embodiment of the present invention, a single variable-mode button 80 includes a plurality of upper and lower electrodes. If the size of the electrodes is reduced as illustrated in FIG. 13, the variable-mode button 80 may be more finely positioned and may have various sizes and shapes.

Accordingly, the input device 110 does not display a predefined grid on the input surface 99.

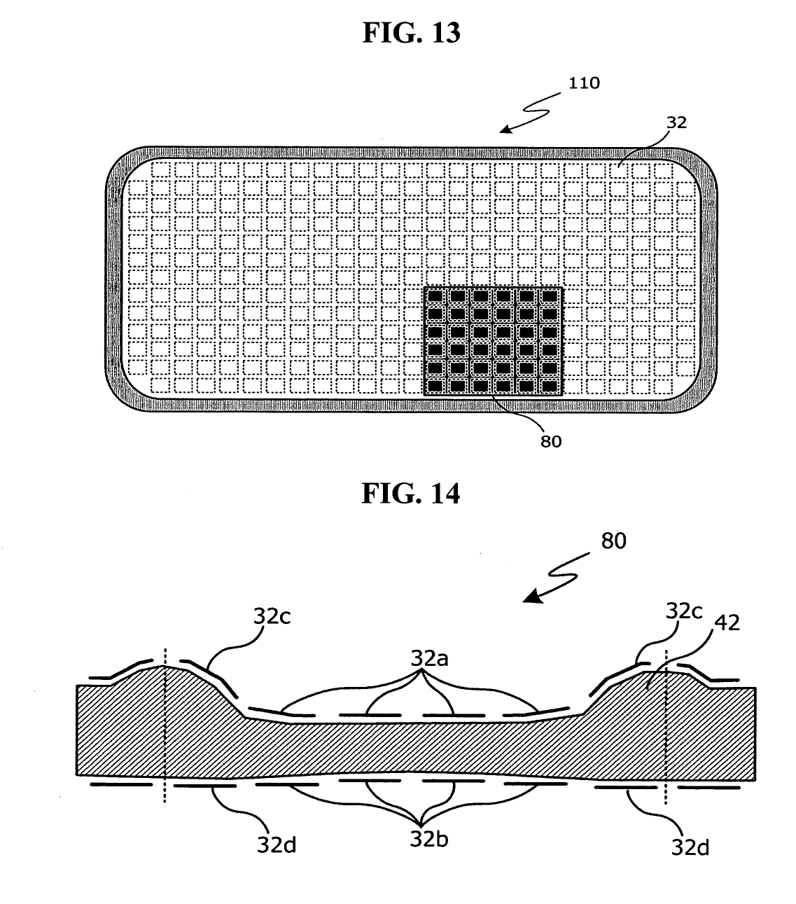

FIG. 14 illustrates a cross-section of the electro-active polymer layer 50 in the variable-mode button 80 illustrated in FIG. 13. For example, when a voltage is applied to only four pairs of upper and lower electrodes 32a and 32b among six pairs of upper and lower electrodes included in the variable-mode button 80, an electro-active polymer only positioned between the electrodes 32a and 32b to which the voltage is applied is expanded and the folds or protrusions 42 are formed upward at an electro-active polymer positioned between two pairs of upper and lower electrodes 32c and 32d, to which the voltage is not applied, at a border (denoted by dotted lines) of the variable-mode button 80. When this situation is applied to the input device 110 illustrated in FIG. 13, the voltage is applied to only sixteen pairs of electrodes at a central portion among thirty six pairs of electrodes included in the variable-mode button 80.

As described above, if the size of electrodes is reduced, the variable-mode button 80 can be generated at various positions and in various sizes. In addition, when the size of electrodes is reduced below a predetermined value, the electro-active polymer layer 50 can substitute for the touch pad layer 60.

In detail, when a point is touched with the stylus pen 14 in a state where an initial power source to all electrodes is stopped, a voltage change occurs at an electrode 32 positioned at the touched point. The voltage change is sensed by a predetermined circuit (not shown). When the electrode 32 is very small, a position of the electrode 32 may be matched to a touch point of the stylus pen 14.

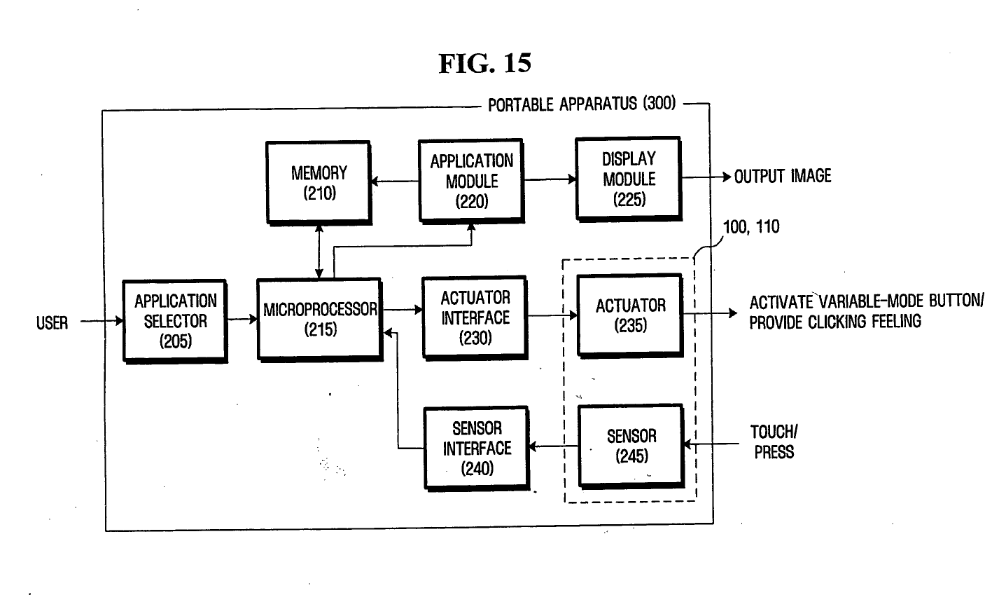

FIG. 15 is a block diagram of a portable apparatus according to an embodiment of the present invention. Referring to FIG. 15, the portable apparatus 300 includes an application selector 205, a microprocessor 215, a memory 210, an application module 220, a display module 225, an actuator interface 230, an actuator 235, a sensor interface 240, and a sensor 245.

The application selector 205 receives an application selection command from a user. The application is one that is appropriate for a particular application. For example, the application may be a call application as illustrated in FIG. 9, a handwriting input application as illustrated in FIG. 10, a video game application as illustrated in FIG. 11, or a multimedia playback application as illustrated in FIG. 12. The application selector 205 transmits a flag (a predetermined command or a bit) corresponding to the selected application to the microprocessor 215.

The microprocessor 215 may include a universal central processing unit (CPU) or a micro computer for a specified function and controls the operations of other elements included in the portable apparatus 30.

To execute the application corresponding to the flag transmitted by the application selector 205, the microprocessor 215 loads the application module 220 to a predetermined region in the memory 210 and executes the loaded application module 220.

In addition, the microprocessor 215 determines an input mode mapped to the application to be executed. For example, the input mode may be a phone number key mode as illustrated in FIG. 9, a touch pad mode as illustrate in FIG. 10, a four-direction key mode as illustrated in FIG. 11, or a multimedia key mode as illustrated in FIG. 12.

A mapping relationship between the application and the input mode may be stored in the memory 210 in the form of a predetermined mapping table. The mapping relation may not be a one-to-one correspondence and may be a many-to-one correspondence. In other words, the same input mode may be used in different applications.

The memory 210 is loaded with the application module 220 at the predetermined region in processor or thread units. In addition, the memory 210 may store the mapping table. In general, the memory 210 may be implemented by a nonvolatile memory such as ROM (read only memory), PROM (programmable ROM), EPROM (electrically programmable ROM), EEPROM (electrically erasable programmable ROM) or a flash memory, a volatile memory such as RAM, a storage medium such as a hard disk, or other different types of memories known in the art.

The application module 220 is loaded to the memory 210 by the microprocessor 215 and then executed. The application module 220 provides an execution procedure or an execution result to the display module 225.

The display module 225 outputs the execution procedure or the execution result of the application module 220 so that a user can visually and/or auditorily perceive it. The display module 225 fundamentally includes any of a liquid crystal display (LCD), a cathode-ray tube (CRT), a plasma display panel (PDP), a light emitting diode (LED), an organic LED (OLED), a three-dimensional goggle, or other image output device and may further include an amplifier and a speaker for audio output.

The input devices 100 and 110 according to embodiments of the present invention include at least the actuator 235 and the sensor 245 and may further include the actuator interface 230 and the sensor interface 240.

The actuator 235 generates and outputs a force or displacement in response to a signal that is generated by the microprocessor 215 and then converted by the actuator interface 230. According to an embodiment of the present invention, the actuator 235 may include the electro-active polymer 31, the electrodes 32 to activate the electro-active polymer 31, and a power source (not shown).

The microprocessor 215 may determine which of the electrodes 32 will be activated with what level of an input voltage according to an input mode corresponding to a current application and transmit a corresponding command to the actuator 235. The actuator 235 activates a corresponding one among the electrode 32 with the determined input voltage according to the command transmitted by the microprocessor 215 via the actuator interface 230. As a result, the variable-mode buttons 40 and 80 are activated in various input modes, as illustrated in FIGS. 9, 11, and 12. In addition, when a clicking feeling is provided as in the embodiment illustrated in FIG. 7C, the actuator 235 receives a related signal from the microprocessor 215 and generates and outputs the clicking feeling.

The actuator interface 230 is connected between the actuator 235 and the microprocessor 215 and converts a signal generated by the microprocessor 215 into a signal appropriate for driving of the actuator 235. As is well known to those skilled in the art, the actuator interface 230 may include a power amplifier, a switch, a digital-to-analog converter (DAC), an analog-to-digital converter (ADC), and other elements.

The sensor 245 generates a signal including information indicating a position where a user's touch or pressure (which may be generally referred to as a “pressure” applied by the user) occurs or indicating a movement and transmits the signal to the microprocessor 215 via the sensor interface 240. The sensor 245 may be implemented by the electro-active polymer layer 50 including the electro-active polymer 31, the electrodes 32, and the power source, by the touch pad layer 60 or the metal dome layer 70, or by a combination of two or more of them for more accurate sensing.

As described above, the electro-active polymer 31 is interactive since it can be changed by a voltage, and conversely, can generate a voltage when it is transformed by an external force. Accordingly, the electro-active polymer 31 may be used as the actuator 235 and the sensor 245.

The metal dome layer 70 can provide a clicking feeling through metal domes arranged at predetermined intervals and includes a contact switch, which is turned on in response to touch or pressure, and therefore, it can be used as the sensor 245.

The sensor interface 240 is connected between the microprocessor 215 and the sensor 245 and converts a signal output from the sensor into a signal that can be analyzed by the microprocessor 215.

Although the portable apparatus 300 illustrated in FIG. 15 has an appropriate environment for the use of the input device 100 or 110, the use of the input devices 100 and 110 according to embodiments of the present invention is not restricted to the portable apparatus 30. The input devices 100 and 110 can be used for desktop computers, laptop computers, digital televisions, home appliances, etc.

The respective components shown in FIG. 15 may be implemented by software components executed in a predetermined area on a memory, such as task, class, subroutine, process, object, execution thread, or program components, or hardware components, such as FPGA (field-programmable gate array) or ASIC (application-specific integrated circuit). The functionality provided for in the components and modules may be combined into fewer components and modules or further separated into additional components and modules. In addition, the components and modules may be implemented such that they execute one or more computers.

According to the present invention, a single user input device that is suitably and adaptively deformable for many applications can be provided.

Accordingly, a user can easily control an apparatus equipped with the input device using the input device.

In addition, the size and the weight of the apparatus can be reduced. Since an input unit is tactually guided, the size of the input device can be reduced and a display area can be increased.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described embodiments have been provided only in a descriptive sense and will not be construed as placing any limitation on the scope of the invention.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An input device, comprising:
a contact surface contacting a user;
an actuator providing a displacement or a force to the contact surface, and an electric circuit controlling the operation of the actuator;
wherein the actuator comprises an electro-active polymer layer including an electro-active polymer and a plurality of electrodes contacting the electro-active polymer;
a first variable-mode button is actuated on the contact surface when power is supplied to a electrode combination among the plurality of electrode; and
a second variable-mode button is actuated on the contact surface when power is supplied to another electrode combination among the plurality of electrode.

2. The input device of claim 1, wherein the electro-active polymer is a dielectric-type electro-restrictive polymer.

3. The input device of claim 1, wherein the electrodes are made using a conductive polymer and a compliant polymer.

4. The input device of claim 1, wherein the shapes of the first and second variable-mode buttons are determined according to the shape of the electrodes.

5. The input device of claim 1, wherein the electro-active polymer is disposed parallel to the contact surface, and the plurality of electrodes are disposed on opposing sides of the electro-active polymer.

6. The user device of claim 5, wherein a portion of the electro-active polymer contacting an electrode to which the power is supplied among the plurality of electrodes is expanded, and a fold or a protrusion is formed in the electro-active polymer at a border between the electrode to which the power is supplied and electrodes to which the power is not supplied.

7. The input device of claim 6, wherein each of the first and second variable-mode buttons comprises one electrode among the plurality of electrodes.

8. The input device of claim 7, wherein a grid corresponding to the plurality of electrodes is formed on the contact surface.

9. The input device of claim 6, wherein each of the first and second variable-mode buttons comprises two or more electrodes among the plurality of electrodes.

10. The input device of claim 1, wherein the first variable-mode button and the second variable-mode button are separately activated for different applications.

11. The input device of claim 10, wherein the applications comprise at least two among a call application, a handwriting input application, a video game application, and a multimedia playback application.

12. The input device of claim 1, further comprising a sensor sensing a position of the first or second variable-mode button that is pressed by a user on the contact surface.

13. The input device of claim 12, wherein the sensor comprises at least one among the electro-active polymer layer, a touch pad layer, and a plurality of contact switches.

14. The input device of claim 1, wherein the actuator further comprises an element providing a clicking feeling to a user pressing the first or second variable-mode button, and the element comprises at least one among a metal dome, a rubber dome, and a spring.

15. The input device of claim 1, the first variable-mode button is different from the second variable-mode button in terms of at least one among a position, a number and a size.

16. An input device comprising a contact surface physically contacting a user, an actuator providing a displacement or a force to the contact surface, and an electric circuit controlling the operation of the actuator,
wherein the actuator comprises an electro-active polymer layer including an electro-active polymer and a plurality of electrodes contacting the electro-active polymer and a touch pad layer sensing a position of pressure applied by a user,
a button mode is activated when power is supplied to a predetermined electrode combination among the plurality of electrodes, and
a touch pad mode is activated when power supplied to the plurality of electrodes is stopped.

17. The input device of claim 16, wherein the electro-active polymer is disposed parallel to the contact surface, and the plurality of electrodes are disposed on opposing sides of the electro-active polymer.

18. The input device of claim 17, wherein a portion of the electro-active polymer contacting an electrode to which the power is supplied among the plurality of electrodes is expanded, and a fold or a protrusion is formed in the electro-active polymer at a border between the electrode to which the power is supplied and electrodes to which the power is not supplied.

19. The input device of claim 18, wherein each of the first and second variable-mode buttons comprises one electrode among the plurality of electrodes.

20. The input device of claim 19, wherein a grid corresponding to the plurality of electrodes is formed on the contact surface.

21. The input device of claim 18, wherein each of the first and second variable-mode buttons comprises two or more electrodes among the plurality of electrodes.

22. The input device of claim 16, wherein the button mode and the touch pad mode are separately activated for different applications.

23. A portable apparatus comprising:
a microprocessor to load an application module corresponding to an application into a memory selected by a user to a memory and executing the loaded application module;
a display module to display to the user an execution procedure or an execution result of the application module; and
an input device to provide alternatively the user with a button mode or a touch pad mode mapped to the application in response to a control signal from the microprocessor.

24. The portable apparatus of claim 23, wherein the input device comprises a contact surface contacting a user and an actuator providing a displacement or a force to the contact surface; the actuator comprises an electro-active polymer layer including an electro-active polymer and a plurality of electrodes contacting the electro-active polymer; a first variable-mode button is actuated on the contact surface, the first variable-mode button having a predetermined number of elements at a predetermined position in a predetermined size, when power is supplied to a predetermined electrode combination among the plurality of electrodes; and a second variable-mode button that is different from the first variable-mode button in at least one among the predetermined number, the predetermined size, and the predetermined position is activated when the power is supplied to another electrode combination.

25. The portable apparatus of claim 24, wherein the display module distinctively displays a screen key or an icon corresponding to a currently activated variable-mode button.

26. The portable apparatus of claim 23, wherein the input device comprises a contact surface physically contacting a user and an actuator providing a displacement or a force to the contact surface; the actuator comprises an electro-active polymer layer including an electro-active polymer and a plurality of electrodes contacting the electro-active polymer and a touch pad layer sensing the position of pressure applied by a user; a button mode is activated when power is supplied to a predetermined electrode combination among the plurality of electrodes; and a touch pad mode is activated when power supplied to the plurality of electrodes is stopped.

27. The portable apparatus of claim 26, wherein when the button mode is activated, the display module distinctively displays a screen key or an icon corresponding to a currently activated variable-mode button.

28. The portable apparatus of claim 24, further comprising an actuator interface connecting the actuator and the microprocessor.

29. An input device, comprising:
an EAP (Electro-Active-Polymer) layer having a plurality of EAPs;
a touch pad layer having a plurality of electrode grids is disposed under the EAP layer and in contact with a the plurality of electrodes;
the plurality of the electrodes are disposed to be in contact with a top side and a bottom side of the EAP layer;
a button is formed on the plurality of the electrodes disposed to the top side of the EAP layer; and
wherein the EAP layer and the touch pad layer are substantially contact with each other.

30. The input device of claim 29, further comprises a layer having at least one dome or one spring disposed under the touch pad layer to provide a clicking feeling to a user.

31. The input device of claim 29, at least a portion of EAP layer's shape is changed by the EAP when the user touches the button.

32. The input device of claim 30, wherein the dome is made of a metal or a rubber.

33. An input device, comprising:
an EAP (Electro-Active-Polymer) layer having a plurality of EAPs;
a touch pad layer having a plurality of electrode grids is disposed under the EAP layer and in contact with a the plurality of electrodes;
a layer having at least one dome or at least one spring and at least one contact switch is disposed under the EAP layer to provide a clicking feeling to a user;
a plurality of the electrodes disposed to be in contact with a top side and a bottom side of the electro-active polymer; and
a button is formed on the plurality of the electrodes disposed to the top side of the EAP layer;
wherein the EAP layer and the layer are substantially contact with each other.
